(19) United States
(12) Patent Application Publication
(10) Pub. No.: US 2012/0126942 A1
(43) Pub. Date: May 24, 2012

(54) TRAINABLE WIRELESS CONTROL SYSTEM

(75) Inventors: Steven L. Geerlings, Holland, MI (US); Mark Zeinstra, Holland, MI (US); James E. Trainor, Holland, MI (US)

(73) Assignee: JOHNSON CONTROLS TECHNOLOGY COMPANY, Holland, MI (US)

(21) Appl. No.: 13/386,762

(22) PCT Filed: Jul. 27, 2010
(86) PCT No.: PCT/US2010/043333

§ 371 Date: Jan. 24, 2012

Related U.S. Application Data
(60) Provisional application No. 61/230,295, filed on Jul. 31, 2009.
(60) Provisional application No. 61/247,052, filed on Sep. 30, 2009.

(51) Int. Cl. G06F 7/04; G08C 19/16

(52) U.S. Cl. 340/5.61; 340/12.28

(57) ABSTRACT

The invention relates to a trainable wireless control system (2) mounted to a vehicle (1) and to a vehicle (1) containing a trainable wireless control system (2), the trainable wireless control system (2) comprising a first module (3) and a second module (4), wherein the first module (3) comprises at least a user interface, wherein the second module (4) comprises at least a transceiver unit (41) and wherein the first module (3) is provided inside the interior of the vehicle (1) and the second module (4) is provided outside the interior of the vehicle (1), wherein the first and second module are connected by a means for transmitting electronic instructions, wherein the system is configured to wirelessly control a wirelessly controllable device external to the vehicle (1).

### CLAIM OF PRIORITY

The present application claims the benefit of the filing date of Provisional Application Nos. 61/230,295 (filed Jul. 31, 2009) and 61/247,052 (tiled Sep. 30, 2009) the contents of which are hereby incorporated by reference in their entirety,

### BACKGROUND OF TH INVENTION

1. Field of the Invention

The present invention generally relates to a trainable wireless control system mounted to a vehicle that is configured to wirelessly control a wirelessly controlled device external to the vehicle.

2. Description of the Prior Art

Trainable transceivers for use with electrically garage door mechanisms are an increasingly popular home convenience. Such transceivers are typically permanently located in a vehicle and are powered by the vehicles battery. These trainable transceivers are capable of learning the radio frequency, modulation scheme, and data code of an existing portable remote RF transmitter associated with an existing receiving unit located in the vehicle owner's garage. Thus, when a vehicle owner purchases a new car having such a trainable transceiver, the vehicle owner may train the transceiver to the vehicle owners existing clip-on remote RF transmitter without requiring any new installation in the vehicle or home. Subsequently, the old clip-on transmitter can be discarded or stored. Suchlike trainable transceivers are typically provided in the interior of the vehicle.

Nowadays, the usage of solar glass decreasing the internal temperatures in the interior of vehicles becomes more and more common. For example, the California Air Resource Broad (CAR) has recently introduced a requirement for all cars going to California to include solar glass. This approach uses metal in the glass causing issues with RF transmission out of the vehicle interior. Consequently, the coverage of the transceivers provided in the vehicle's Interior will strongly be decreased.

Furthermore, it is known from US 2007/0279304 A1 to provide at least one antenna device in a fin-like housing at the exterior of the vehicle.

### SUMMARY

It is an object of the present invention to provide a trainable wireless control system mounted to a vehicle that is configured to wirelessly control a wirelessly controlled device external to the vehicle that ensures a secure and reliable signal transmission and that does not have the drawbacks mentioned in connection with the prior art.

In order to accomplish these and other objects of the invention, there is provided a trainable wireless control system mounted to a vehicle that is configured to wirelessly control a wirelessly controlled or wirelessly controllable device external to the vehicle, the, wireless control system comprising a first module and a second module, wherein the first module comprises a user interface, e.g. at least a button pad and/or a receiver unit, and wherein the second module comprises at least a transmitter unit or a transceiver unit, wherein the first module is provided inside the interior of the vehicle and the second module is provided outside of the interior of the vehicle, and wherein the first and second module are connected by a means for transmitting electronic instructions.

Thereby, it is advantageously possible to easily provide the possibility to control the trainable wireless control system (and thereby to control the wirelessly controlled or wirelessly controllable device external to the vehicle such as a garage door or the like) by means of a user being inside of the vehicle and accessing the first module, and at the same time ensuring a reliable wireless communication between the (transmitter or transceiver unit of the) second module and the wirelessly controlled or wirelessly controllable device external to the vehicle for all circumstances such as metalized coatings of solar glass components decreasing the internal temperatures in the interior of vehicles. The wirelessly controlled device external to the vehicle comprises, e.g., a garage door opener, and/or house lights, and/or access gates and/or other controlled devices that are especially fixedly installed at a house or another building.

According to a preferred embodiment of the present invention, the means for transmitting electronic instructions comprises one or more of a local interconnect network or a bus. Alternatively to such a wireline realization of the means for transmitting electronic instructions, the means for transmitting electronic instructions can also be realized by means of a wireless connection between the first and second module and/or by means of a wireless connection for at least a part of the distance between the first and second module of the trainable wireless control system. In case that the second module needs to receive wireless (radio) signals, a transceiver unit is used in the second module. In case that the second module does not need to receiver wireless (radio) signals, it is possible that only a transmitter unit is used in the second module.

It is thereby advantageously possible to provide a reliable communication link between the first and second module of the wireless control system.

According to a preferred embodiment of the present invention, the second module is provided in a fin-like housing at the outside of the vehicle, preferably on the roof of the vehicle. According to an alternative preferred embodiment of the present invention, the second module is provided in a bumper of the vehicle, preferably in a front bumper of the vehicle.

According to all the embodiments of the present invention, it is advantageously possible that a user staying in the interior of the vehicle trains and/or operates the trainable wireless control system, wherein the electromagnetic radiation of the transceiver unit (or transmitter unit) for controlling the wirelessly controlled device (external to the vehicle) is not shielded by body components or solar glass of the vehicle. Consequently, both
the transmission reliability for data transmission between the transceiver unit/transmitter unit and the wirelessly controlled device, and
the transmission reliability for data transmission between the receiver unit and an original remote control unit for training the trainable wireless control system are increased. Furthermore, the range of the transceiver unit/transmitter unit concerning the surrounding of the vehicle is increased compared to the state of the art.

In a preferred embodiment of the wireless control system, the first and/or the second modules comprise microcontroller and/or ASIC's (Application Specific Integrated Circuit) for data processing of transmitted signals between the first and the second modules, transmitted signals between the transceiver unit (transmitter unit) and the wirelessly controlled device, received signals of the receiver unit, received user inputs and/or the like. Preferably, the microcontroller in the first module and the receiver unit are used for training different types and/or brands of remotely controlled devices using radio frequencies. For that purpose, a user staying inside the interior of the vehicle preferably activates an original remote control unit, so that the receiver unit receives the physical transfer characteristics and/or the scrambling codes of the original remote control unit and configures the trainable wireless control system, accordingly.

In another preferred embodiment the first and the second modules are connected to each other via a Local Interconnect Network (LIN) or other buses, like CAN (Controller Area Network) to communicate needed information. Preferably, the first and the second modules communicate via a wireless connection.

The wirelessly controlled device particularly comprises a garage door opener, house lights, access gates or other remotely controlled devices.

According to preferred embodiments of the present invention, the second module is provided near or on the top (roof) of the vehicle and/or the second module is provided near to or inside of the bumper of the vehicle. In particular, the first module is, provided in a rearview mirror of the vehicle and/or in a dashboard area of the vehicle.

Preferably, since the transceiver unit (of the second module) is located outside the cabin of the vehicle, the transceiver unit (of the second module) is used for receiving RE remote keyless entry (RKE) signals, wherein a second interface unit is used for transmitting the received RE keyless entry signals via a vehicle bus to the body control module. Additionally, it is preferred according to the present invention to integrate a GPS functionality (i.e. the functionality to receive satellite signals of a satellite navigation system like the Global Positioning System) in the second module and/or to integrate a cellular functionality (i.e. the functionality to receive and to transmit telecommunication signals of a cellular mobile radio network) in the second module. Alternatively or cumulatively, the transceiver unit (of the second module) is used for receiving Tire-pressure monitoring systems (TPMS) signals.

Another object of the present invention is a method for training a wireless control system according to the present invention, wherein in an initial training mode of the wireless control system the receiver unit of the first module receives a radiofrequency actuation signal and wherein in an operating mode of the wireless control system the transceiver unit of the second module transmits a control signal imitating the physical characteristics and/or the scrambling codes of the received actuation signal, wherein the physical characteristics and/or the scrambling codes are transmitted from the inside of the interior of the vehicle to the outside of the interior of the vehicle.

Another object of the, present invention relates to a vehicle containing a trainable wireless control system mounted to the vehicle comprising a first module and a second module, wherein the first module comprises at least a user interface, wherein the second module comprises at least a transceiver unit (or a transmitter unit) and wherein the first module is provided inside of the interior of the, vehicle and the second module is provided outside of the interior of the vehicle, wherein the first and second module are connected by a means for transmitting electronic instructions, wherein the system is configured to wirelessly control a wirelessly controlled or wirelessly controllable device external to the vehicle.

### BRIEF DESCRIPTION OF THE DRAWINGS

FIGS. 1 and 2 exemplary show schematical representations of the trainable wireless control system according to a first embodiment of the present invention.

FIG. 3 exemplary shows schematical representations of the trainable wireless control system according to a second embodiment of the present invention.

### DETAILED DESCRIPTION

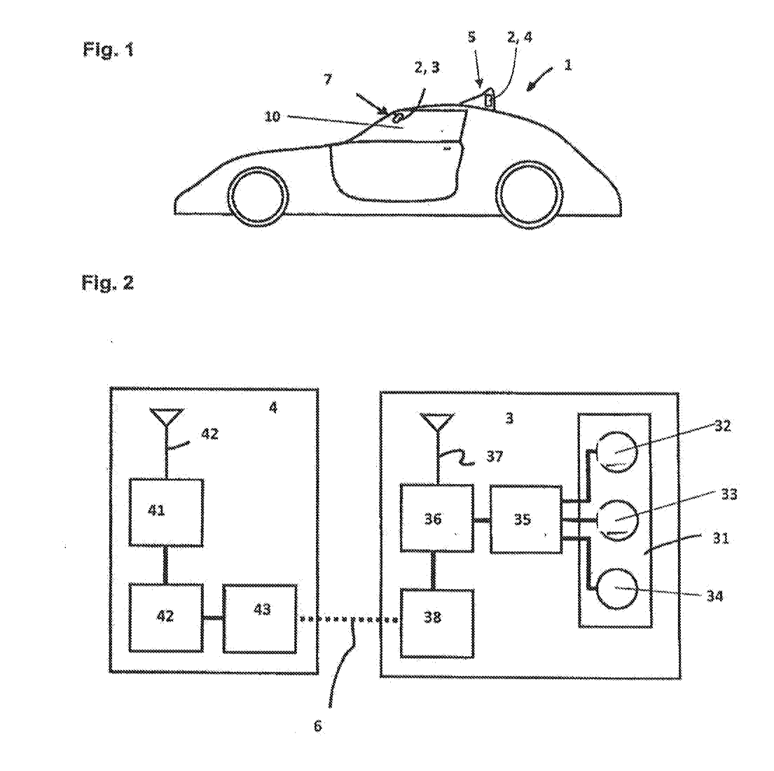

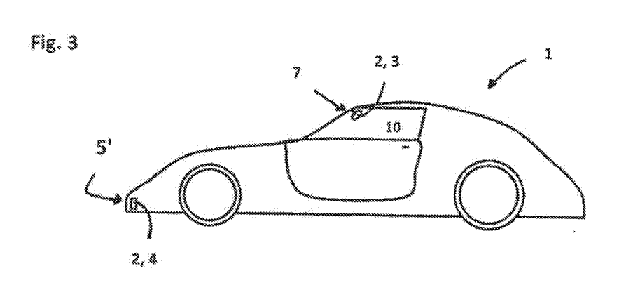

In FIGS. 1 and 3, a vehicle 1 is schematically represented. The vehicle 1 comprises solar glass windows 10 and is provided with a trainable wireless control system 2. A first module 3 of the trainable wireless control system 2 is provided inside the interior of the vehicle 1, whereas a second module 4 of the wireless control system 2 is provided outside the interior of the vehicle 1, e.g. in a fin-like housing 5 in a roof area of the vehicle (according to the first embodiment of the present invention, cf. FIG. 1) or in a bumper 5′ (according to the second embodiment of the present invention, cf. FIG. 3). The first module 3 is provided, e.g., in a rearview mirror 7 of the vehicle, for instance.

In FIG. 2, the design of the first and the second module 3, 4 of the trainable wireless control system 2 is illustrated, in detail, for both the first and second embodiment according to the present invention. The second module 4 comprises a transceiver unit 41 or a transmitter unit 41 cooperating with a second antenna 42. The transceiver or transmitter unit 41 is controlled by a second microcontroller 42 communicating with the first module 3 via a second interface unit 43. The transceiver or transmitter unit 41 is provided for transmitting control signals to a wirelessly controllable device external to the vehicle 1, e.g. a garage door opener. A button pad 31 or other user interface of the first module 3 exemplary comprises three different buttons 32, 33, 34 operable by a user staying inside the interior of the vehicle 1. The buttons 32, 33, 34 are operably connected to a first microcontroller 35. The first microcontroller 35 controls a first interface unit 38 for transmitting control signals to the second interface unit 43 of the second module 4 via a wireless or hardwired connection 6. Furthermore, a receiver unit 36 of the first module 3 cooperates with a first antenna 37 of the first module 3. In a training mode of the wireless control system the receiver unit 36 is capable of receiving radiofrequency actuation signals from an original remote controller of the wirelessly controllable device actuated by the user inside the interior of the vehicle 1 and learns the physical transfer characteristics and/or the scrambling codes of these radiofrequency actuation signals. The training mode is activated by pressing one of the buttons 32, 33, 34, for instance. The extracted physical transfer characteristics and/or the scrambling codes are used by the transceiver or transmitter unit 41 for transmitting the control signal to the wirelessly controllable device in an operating mode of the wireless control system Consequently, the, trainable wireless control system 2 can be trained for the usage with different types and/or brands of remotely controlled devices using radio frequencies.

Although only certain embodiments of the invention have been described herein it will be understood by any person skilled in the art that other modifications variations and possibilities of the invention are possible without departing from the broader spirit of the invention. Such modifications, variations and possibilities are therefore to be considered as falling within the spirit and scope of the invention and hence forming part of the invention as herein described and/or exemplified. Accordingly, the specification and drawings are to be regarded in an illustrative sense rather than in a restrictive sense.

In particular, the first module can be provided anywhere aside the vehicle interior, wherein the second module can be provided anywhere at the car outside the vehicle interior.

1. A trainable wireless control system mounted to a vehicle comprising a first module and a second module, wherein the first module comprises at least a user interface, wherein the second module comprises at least a transmitter unit and wherein the first module is provided inside the interior of the vehicle and the second module is provided outside the interior of the vehicle, wherein the first and second module are connected by a means for transmitting electronic instructions, wherein the system is configured to wirelessly control a wirelessly controllable device external to the vehicle.

2. A trainable wireless control system according to claim 1 wherein the means for transmitting electronic instructions comprises one or more of a local interconnect network or bus.

3. A trainable wireless control system according to claim 1 wherein the second module (4) comprises a transmitter unit and wherein the means for transmitting electronic instructions is a wireless connection.

4. A trainable wireless control system according to claim 1 wherein the wirelessly controlled device external to the vehicle comprises a garage door opener, house lights, access gates or other remotely controlled devices.

5. A trainable wireless control system according to claim 1 wherein the transceiver of the second module is used for transmitting the received RF keyless entry signals via a vehicle bus to a body control module.

6. A trainable wireless control system according to claim 1 wherein the transceiver of the second module is used for receiving tire-pressure monitoring systems signals.

7. A vehicle containing a trainable wireless control system mounted to the vehicle comprising a first module and a second module, wherein the first module comprises at least a user interface, wherein the second module comprises at least a transmitter unit and wherein the first module is provided inside the interior of the vehicle and the second module is provided outside the interior of the vehicle, wherein the first and second module are connected by a means for transmitting electronic instructions, wherein the system is configured to wirelessly control a wirelessly controllable device external to the vehicle.

8. A vehicle containing a trainable wireless control system mounted according to claim 7, wherein the first module is located in a rearview mirror of the vehicle and the second module is located in a fin-like housing in a roof area of the vehicle or in the bumper of the vehicle.

9. A vehicle containing a trainable wireless control system mounted according to claim 7, wherein the first module is located in a rearview mirror of the vehicle and the second module is located in the bumper of the vehicle.

10. A vehicle according to claim 7 wherein the means for transmitting electronic instructions comprises one or more of a local interconnect network or bus.

11. A vehicle according to claim 7 wherein the second module comprises a transmitter unit and wherein the means for transmitting electronic instructions comprise a wireless connection.

12. A vehicle according to claim 7 wherein the wirelessly controlled device external to the vehicle comprises a garage door opener, house lights, access gates or other remotely controlled devices.

13. A vehicle according claim 7 wherein the transceiver of the second module is used for transmitting the received RF keyless entry signals via a vehicle bus to a body control module.

14. A vehicle according to claim 7 wherein the transceiver of the second module is used for receiving tire-pressure monitoring systems signals.

15. A vehicle according to claim 8 wherein the means for transmitting electronic instructions comprises one or more of a local interconnect network or bus.

16. A vehicle according to claim 8 wherein the second module comprises a transmitter unit and wherein the means for transmitting electronic instructions comprise a wireless connection.

17. A vehicle according to claim 8 wherein the wirelessly controlled device external to the vehicle comprises a garage door opener, house lights, access gates or other remotely controlled devices.

18. A vehicle according to claim 8 wherein the transceiver of the second module is used for transmitting the received RF keyless entry signals via a vehicle bus to a body control module.

19. A vehicle according to claim 8 wherein the transceiver of the second module is used for receiving tire-pressure monitoring systems signals.

20. A vehicle containing a trainable wireless control system mounted according to claim 8, wherein the first module is located in a rearview mirror of the vehicle and the second module is located in a fin-like housing in a roof area of the vehicle.
